(19) United States
(12) Patent Application Publication
(10) Pub. No.: US 2012/0191231 A1
(43) Pub. Date: Jul. 26, 2012

(54) Methods and Systems for Identifying Content in Data Stream by a Client Device

(75) Inventor: Avery Li-Chun Wang, Palo Alto, CA (US)

(73) Assignee: SHAZAM ENTERTAINMENT LTD., London (GB)

(21) Appl. No.: 13/396,390

(22) Filed: Feb. 14, 2012

Related U.S. Application Data
(63) Continuation-in-part of application No. 13/101,051, filed on May 4, 2011.
(60) Provisional application No. 61/495,571, filed on Jun. 10, 2011.
(60) Provisional application No. 61/331,015, filed on May 4, 2010.
(60) Provisional application No. 61/444,458, filed on Feb. 18, 2011.

(51) Int. Cl. G06F 17/00

(52) U.S. Cl. 700/94

(57) ABSTRACT

Methods and systems for identifying content in a data stream by a client device are provided. The methods may include receiving at the client device a signature file that is indicative of one or more features extracted from media content and information identifying the media content. The method may also include based on a comparison with the signature file, the client device performing a content identification of received media content rendered by a media rendering source. The client device may receive a set of signature files based on any number of factors including a physical location of the client device, a network address of the client device, a previous content recognition request of the client device, a genre preference, an artist preference, and a user profile.

### CROSS-REFERENCE TO RELATED APPLICATIONS

The present application claims priority to U.S. provisional application Ser. No. 61/495,571 filed on Jun. 10, 2011, the entire contents of which are herein incorporated by reference. The present application also claims priority to U.S. patent application Ser. No. 13/101,051 filed on May 4, 2011, which claims the benefit of U.S. provisional application No. 61/331,015 filed on May 4, 2010 and U.S. provisional application No. 61/444,458 filed on Feb. 18, 2011, the entire contents of each are all herein incorporated by reference. The entire contents of each cross-referenced related application are herein incorporated by reference.

### FIELD

The present disclosure relates to identifying content in a media stream. For example, the present disclosure relates to a client device performing a content identification of content in a media stream based on signature files stored on the client device.

### BACKGROUND

Content identification systems for various data types, such as audio or video, use many different methods. A client device may capture a media sample recording of a media stream (such as radio), and may then request a server to perform a search in a database of media recordings (also known as media tracks) for a match to identify the media stream. For example, the sample recording may be passed to a content identification server module, which can perform content identification of the sample and return a result of the identification to the client device. A recognition result may then be displayed to a user on the client device or used for various follow-on services, such as purchasing or referencing related information. Other applications for content identification include broadcast monitoring or content-sensitive advertising, for example.

Existing content identification systems may require user interaction to initiate a content identification request. Often times, a user may initiate a request after a song has ended, for example, missing an opportunity to identify the song.

In addition, within content identification systems, a central server receives content identification requests from client devices and performs computational intensive procedures to identify content of the sample. A large number of requests can cause delays when providing results to client devices due to a limited number of servers available to perform a recognition.

### SUMMARY

In some examples, a method is provided comprising receiving at a client device a signature file, and the signature file is indicative of one or more features extracted from media content and information identifying the media content. The method also comprises based on a comparison with the signature file, the client device performing a content identification of received media content rendered by a media rendering source.

In other examples, a method is provided comprising determining, by a server, a set of signature files from a database of signature files for a client device, and each signature file is indicative of one or more features extracted from a respective media content and information identifying the respective media content. The method also comprises providing the set of signature files to the client device.

Any of the methods described herein may be provided in a form of instructions stored on a non-transitory, computer readable medium, that when executed by a computing device, cause the computing device to perform functions of the method. Further examples may also include articles of manufacture including tangible computer-readable media that have computer-readable instructions encoded thereon, and the instructions may comprise instructions to perform functions of the methods described herein.

In still further examples, any type of devices may be used or configured to perform logical functions in any processes or methods described herein.

In other examples, a client device is provided comprising a database and a content identification module coupled to the database. The database is configured to receive and store a signature file, and the signature file is indicative of one or more features extracted from media content and information identifying the media content. The content identification module is configured to perform a content identification of received media content rendered by a media rendering source based on a comparison with the signature file.

In still other examples, a server is provided comprising a database configured to store signature files, and each signature file is indicative of one or more features extracted from a respective media content and information identifying the respective media content. The server also includes a content identification module coupled to the database and configured to determine a set of signature files from the stored signature files for a client device, and to provide the set of signature files to the client device to enable the client device to perform a content identification of received media content.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates one example of a system for identifying content within a data stream.

FIG. 2 illustrates an example system to prepare a signature.

FIG. 3 illustrates an example content identification method.

FIG. 4 shows a flowchart of an example method for identifying content in a data stream.

FIG. 5 illustrates an example system for identifying content in a data stream and determining signature files for a client device.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

This disclosure may describe, inter alia, methods and systems for identifying content in a data stream by a client device. The methods may include receiving at the client device a signature file that is indicative of one or more features extracted from media content and information identifying the media content. The method may also include based on a comparison with the signature file, the client device performing a content identification of received media content rendered by a media rendering source. The client device may receive a set of signature files based on any number of factors including a physical location of the client device, a network address of the client device, a previous content recognition request of the client device, a genre preference, an artist preference, and a user profile.

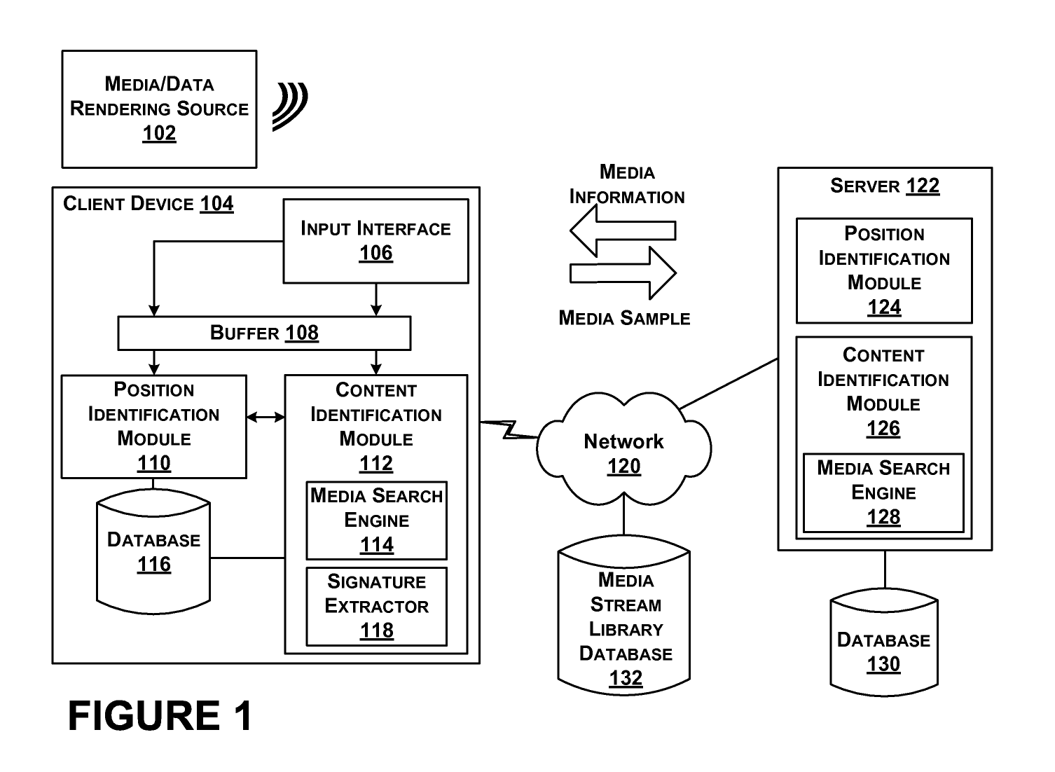

Referring now to the figures, FIG. 1 illustrates one example of a system for identifying content within a data stream. While FIG. 1 illustrates a system that has a given configuration, the components within the system may be arranged in other manners. The system includes a media or data rendering source 102 that renders and presents content from a media stream in any known manner. The media stream may be stored on the media rendering source 102 or received from external sources, such as an analog or digital broadcast. In one example, the media rendering source 102 may be a radio station or a television content provider that broadcasts media streams (e.g., audio and/or video) and/or other information. The media rendering source 102 may also be any type of device that plays or audio or video media in a recorded or live format. In an alternate example, the media rendering source 102 may include a live performance as a source of audio and/or a source of video, for example. The media rendering source 102 may render or present the media stream through a graphical display, audio speakers, a MIDI musical instrument, an animatronic puppet, etc., or any other kind of presentation provided by the media rendering source 102, for example.

A client device 104 receives a rendering of the media stream from the media rendering source 102 through an input interface 106. In one example, the input interface 106 may include antenna, in which case the media rendering source 102 may broadcast the media stream wirelessly to the client device 104. However, depending on a form of the media stream, the media rendering source 102 may render the media using wireless or wired communication techniques. In other examples, the input interface 106 can include any of a microphone, video camera, vibration sensor, radio receiver, network interface, etc. As a specific example, the media rendering source 102 may play music, and the input interface 106 may include a microphone to receive a sample of the music.

Within examples, the client device 104 may not be operationally coupled to the media rendering source 102, other than to receive the rendering of the media stream. In this manner, the client device 104 may not be controlled by the media rendering source 102, and may not be an integral portion of the media rendering source 102. In the example shown in FIG. 1, the client device 104 is a separate entity from the media rendering source 102.

The input interface 106 is configured to capture a media sample of the rendered media stream. The input interface 106 may be preprogrammed to capture media samples continuously without user intervention, such as to record all audio received and store recordings in a buffer 108. The buffer 108 may store a number of recordings, or may store recordings for a limited time, such that the client device 104 may record and store recordings in predetermined intervals, for example, or in a way so that a history of a certain length backwards in time is available for analysis. In other examples, capturing of the media sample may be caused or triggered by a user activating a button or other application to trigger the sample capture. For example, a user of the client device 104 may press a button to record a ten second digital sample of audio through a microphone, or to capture a still image or video sequence using a camera.

The client device 104 can be implemented as a portion of a small-form factor portable (or mobile) electronic device such as a cell phone, a wireless cell phone, a personal data assistant (PDA), tablet computer, a personal media player device, a wireless web-watch device, a personal headset device, an application specific device, or a hybrid device that include any of the above functions. The client device 104 can also be implemented as a personal computer including both laptop computer and non-laptop computer configurations. The client device 104 can also be a component of a larger device or system as well.

The client device 104 further includes a position identification module 110 and a content identification module 112. The position identification module 110 is configured to receive a media sample from the buffer 108 and to identify a corresponding estimated time position (T_{S}) indicating a time offset of the media sample into the rendered media stream (or into a segment of the rendered media stream) based on the media sample that is being captured at that moment. The time position (T_{S}) may also, in some examples, be an elapsed amount of time from a beginning of the media stream. For example, the media stream may be a radio broadcast, and the time position (T_{S}) may correspond to an elapsed amount of time of a song being rendered.

The content identification module 112 is configured to receive the media sample from the buffer 108 and to perform a content identification on the received media sample. The content identification identifies a media stream, or identifies information about or related to the media sample. The content identification module 112 may configured to receive samples of environmental audio, identify a musical content of the audio sample, and provide information about the music, including the track name, artist, album, artwork, biography, discography, concert tickets, etc.

In this regard, the content identification module 112 includes a media search engine 114 and may include or be coupled to a database 116 that indexes reference media streams, for example, to compare the received media sample with the stored information so as to identify tracks within the received media sample. Once tracks within the media stream have been identified, track identities or other information may be displayed on a display of the client device 104.

The database 116 may store content patterns that include information to identify pieces of content. The content patterns may include media recordings such as music, advertisements, jingles, movies, documentaries, television and radio programs. Each recording may be identified by a unique identifier (e.g., sound ID). Alternatively, the database 116 may not necessarily store audio or video files for each recording, since the sound IDs can be used to retrieve audio files from elsewhere. The content patterns may include other information (in addition to or rather than media recordings), such as reference signature files including a temporally mapped collection of features describing content of a media recording that has a temporal dimension corresponding to a timeline of the media recording, and each feature may be a description of the content in a vicinity of each mapped timepoint. Generally, features in the signature file can be chosen to be reproducible in the presence of noise and distortion, for example. The features may be extracted from media recordings sparsely at discrete time positions, and each feature may correspond to a feature of interest. Examples of sparse features include Lₚ norm power peaks, spectrogram energy peaks, linked salient points, etc. For more examples, the reader is referred to U.S. Pat. No. 6,990,453, by Wang and Smith, which is hereby entirely incorporated by reference.

Alternatively, a continuous time axis could be represented densely, in which every value of time has a corresponding feature value that may be included or represented in a signature file for a media recording. Examples of such dense features include feature waveforms (as described in U.S. Pat. No. 7,174,293 to Kenyon, which is hereby entirely incorporated by reference), spectrogram bitmap rasters (as described in U.S. Pat. No. 5,437,050, which is hereby entirely incorporated by reference), an activity matrix (as described in U.S. Publication Patent Application No. 2010/0145708, which is hereby entirely incorporated by reference), and an energy flux bitmap raster (as described in U.S. Pat. No. 7,549,052, which is hereby entirely incorporated by reference).

In one example, a signature file includes a sparse feature representation of a media recording. The features of the recording may be obtained from a spectrogram extracted using overlapped short-time Fast Fourier Transforms (FFT). Peaks in the spectrogram can be chosen at time-frequency locations where a corresponding energy value is a local maximum. For examples, peaks may be selected by identifying maximum points in a region surrounding each candidate location. A psychoacoustic masking criterion may also be used to suppress inaudible energy peaks. Each peak can be coded as a pair of time and frequency values. Additionally, an energy amplitude of the peaks may be recorded. In one example, an audio sampling rate is 8 KHz, and an FFT frame size may vary between about 64-1024 bins, with a hop size between frames of about 25-75% overlap with the previous frame. Increasing a frequency resolution may result in less temporal accuracy. Additionally, a frequency axis could be warped and interpolated onto a logarithmic scale, such as mel-frequency.

A number of features or information associated with the features may be combined into a signature file. A signature file may order features as a list arranged in increasing time. Each feature Fⱼ can be associated with a time value tⱼ in a data construct, and the list can be an array of such constructs; here j is the index of the j-th construct, for example. In an example using a continuous time representation, e.g., successive frames of a spectrogram, the time axis could be implicit in the index into the list array. The time axis within each media recording can be obtained as an offset from a beginning of the recording, and thus time zero refers to the beginning of the recording.

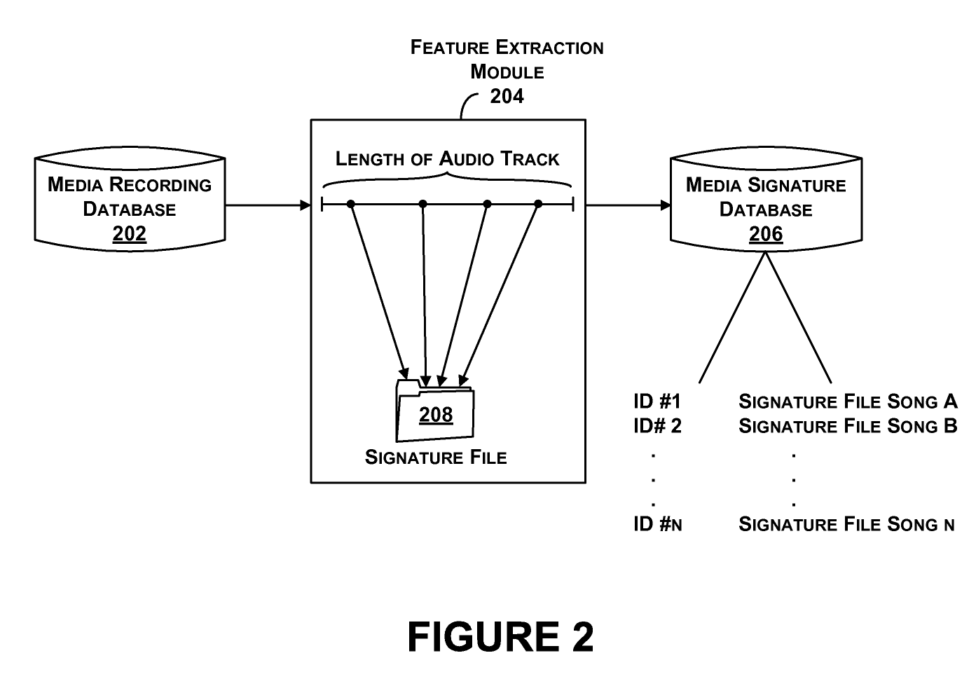

FIG. 2 illustrates an example system to generate a signature file. The system includes a media recording database 202, a feature extraction module 204, and a media signature database 206. The media recording database 202 may include a number of copies of media recordings (e.g., songs or videos) or references to a number of copies of the media recordings. The feature extraction module 204 may be coupled to the media recording database 202 and may receive the media recordings for processing. FIG. 2 conceptually illustrates the feature extraction module receiving an audio track from the media recording database 202.

The feature extraction module 204 may extract features from the media recording, using any of the example methods described above, to generate a signature file 208 for the media recording. The feature extraction module 204 may store the signature file 208 in the media signature database 206. The media signature database 206 may store signature files with an associated identifier, as shown in FIG. 2, for example. Generation of the signature files may be performed in a batch mode and a library of reference media recordings can be preprocessed into a library of corresponding feature-extracted reference signature files, for example. Media recordings input to the feature extraction module 204 may be stored into a buffer (e.g., where old recordings are sent out of a rolling buffer and new recordings are received). Features may be extracted and a signature file may be created continuously from continuous operation of the rolling buffer of media recordings so as to represent no gaps in time, or in an on-demand basis as needed. In the on-demand example, the feature extraction module 204 may retrieve media recordings as necessary out of the media recording database 202 to extract features in response to a request for corresponding features. In one example, the resulting library of reference signature files can then be stored or provided to the client device 104.

A size of a resulting signature file may vary depending on a feature extraction method used. In one example, a density of selected spectrogram peaks (e.g., features) may be chosen to be about between 10-50 points per second. The peaks can be chosen as the top N most energetic peaks per unit time, for example, the top 10 peaks in a one-second frame. In an example using 10 peaks per second, using 32 bits to encode each peak frequency (e.g., 8 bits for the frequency value and 24 bits to encode the time offset), 40 bytes per second may be required to encode the features. With an average song length of about three minutes, a signature file size of approximately 7.2 kilobytes may result for a song. For other signature encoding methods, for example, a 32-bit feature at every offset of a spectrogram with a hop size of 100 milliseconds, a similar size fingerprint results.

In another example, a signature file may be on the order of about 5-10 KB, and may correspond to a portion of a media recording from which a sample was obtained that is about 20 seconds long and refers to a portion of the media recording after an end of a captured sample.

In some examples, the signature file may represent a fingerprint of a media recording by describing features of the recording. In this regard, signatures of a media recording may be considered fingerprints of recording, and signatures or fingerprints may be included in a signature file.

The system shown in FIG. 2 may be included within the client device 104 or a server 122. In an example in which the system is included in the client device, the media recording database 202 may include locally stored media (e.g., music library). In other examples, the client device 104 may receive raw content (e.g., music files) from a server or captured from a stream such as a radio broadcast, streaming internet radio, etc., and perform signature extraction to populate the database 116 with signature files. In still other examples, upon receiving a new media recording (e.g., user purchases a new song and downloads the song to the client device 104), the client device 104 may extract signature features to generate a signature file for the new media recording. The client device 104 may associate information with generated signature files, such as information identifying the raw content (e.g., song title, artist, genre, etc.), advertisements, etc., or any information received from a server that is associated with the raw content.

Referring back to FIG. 1, the database 116 may include a signature file for a number of media recordings, and may continually be updated to include signature files for new media recordings. The database 116 may receive instructions to delete old signature files as well as instructions to incorporate new signature files from a server. The database 116 may further include information associated with extracted features of a media file. The database 116 may include a number of signature files enabling the client device 104 to perform content identifications of content matching to the locally stored signature files.

The database 116 may also include information for each stored signature file, such as metadata that indicates information about the signature file like an artist name, a length of song, lyrics of the song, time indices for lines or words of the lyrics, album artwork, or any other identifying or related information to the file. Metadata may also comprise data and hyperlinks to other related content and services, including recommendations, ads, offers to preview, bookmark, and buy musical recordings, videos, concert tickets, and bonus content; as well as to facilitate browsing, exploring, discovering related content on the world wide web.

The content identification module 112 may also include a signature extractor 118 that may be configured to generate a signature stream of extracted features from captured media samples, and each feature may have a corresponding time position within the sample. The signature stream of extracted features can be used to compare to stored signature files in the database 116 to identify a corresponding media recording. In some examples, the signature extractor 116 may be configured to extract features from a media sample using any of the methods described above for generating a signature file, to generate a signature stream of extracted features. A signature stream may be determined and generated in real-time based on an observed media stream, for example.

The content identification module 112 and/or the signature extractor 118 may further be configured to compare alignment of features within the media sample and the signature file to identify matching features at corresponding times.

The system in FIG. 1 further includes a network 120 to which the client device 104 may be coupled via a wireless or wired link. A server 122 is provided coupled to the network 120, and the server 122 includes a position identification module 124 and a content identification module 126. Although FIG. 1 illustrates the server 122 to include both the position identification module 124 and the content identification module 126, either of the position identification module 124 and/or the content identification module 126 may be separate entities apart from the server 122, for example. In addition, the position identification module 124 and/or the content identification module 126 may be on a remote server connected to the server 122 over the network 120, for example.

In some examples, the client device 104 may capture a media sample and may send the media sample over the network 120 to the server 122 to determine an identity of content in the media sample. The position identification module 124 and the content identification module 126 of the server 122 may be configured to operate similar to the position identification module 110 and the content identification module 112 of the client device 104. In this regard, the content identification module 126 includes a media search engine 128 and may include or be coupled to a database 130 that indexes reference media streams, for example, to compare the received media sample with the stored information so as to identify tracks within the received media sample. Once tracks within the media stream have been identified, track identities or other information may be returned to the client device 104.

In response to a content identification query received from the client device 104, the server 122 may identify a media recoding from which the media sample was obtained, and/or retrieve a signature file corresponding to identified media recording. The server 122 may then return information identifying the media recording, and a signature file corresponding to the media recording to the client device 104.

In other examples, the client device 104 may capture a sample of a media stream from the media rendering source 102, and may perform initial processing on the sample so as to create a signature file/fingerprint of the media sample. The client device 104 may then send the fingerprint information to the position identification module 124 and/or the content identification module 126 of the server 122, which may identify information pertaining to the sample based on the fingerprint information alone. In this manner, more computation or identification processing can be performed at the client device 104, rather than at the server 122, for example.

In still other examples, as described above, the client device 104 may further be configured to perform content identifications locally by comparing alignment of features within the media sample and signature files to identify matching features at corresponding times.

Various content identification techniques are known in the art for performing computational content identifications of media samples and features of media samples using a database of media tracks. The following U.S. Patents and publications describe possible examples for media recognition techniques, and each is entirely incorporated herein by reference, as if fully set forth in this description: Kenyon et al, U.S. Pat. No. 4,843,562, entitled “Broadcast Information Classification System and Method”; Kenyon, U.S. Pat. No. 4,450,531, entitled “Broadcast Signal Recognition System and Method”; Haitsma et al, U.S. Patent Application Publication No. 2008/0263360, entitled “Generating and Matching Hashes of Multimedia Content”; Wang and Culbert, U.S. Pat. No. 7,627,477, entitled “Robust and Invariant Audio Pattern Matching”; Wang, Avery, U.S. Patent Application Publication No. 2007/0143777, entitled “Method and Apparatus for Identification of Broadcast Source”; Wang and Smith, U.S. Pat. No. 6,990,453, entitled “System and Methods for Recognizing Sound and Music Signals in High Noise and Distortion”; Blum, et al, U.S. Pat. No. 5,918,223, entitled “Method and Article of Manufacture for Content-Based Analysis, Storage, Retrieval, and Segmentation of Audio Information”; and Master, et al, U.S. Patent Application Publication No. 2010/0145708, entitled “System and Method for Identifying Original Music”.

Briefly, the content identification module (within the client device 104 or the server 122) may be configured to receive a media recording and sample the media recording. The recording can be correlated with digitized, normalized reference signal segments to obtain correlation function peaks for each resultant correlation segment to provide a recognition signal when the spacing between the correlation function peaks is within a predetermined limit. A pattern of RMS power values coincident with the correlation function peaks may match within predetermined limits of a pattern of the RMS power values from the digitized reference signal segments, as noted in U.S. Pat. No. 4,450,531, which is entirely incorporated by reference herein, for example. The matching media content can thus be identified. Furthermore, the matching position of the media recording in the media content is given by the position of the matching correlation segment, as well as the offset of the correlation peaks, for example.

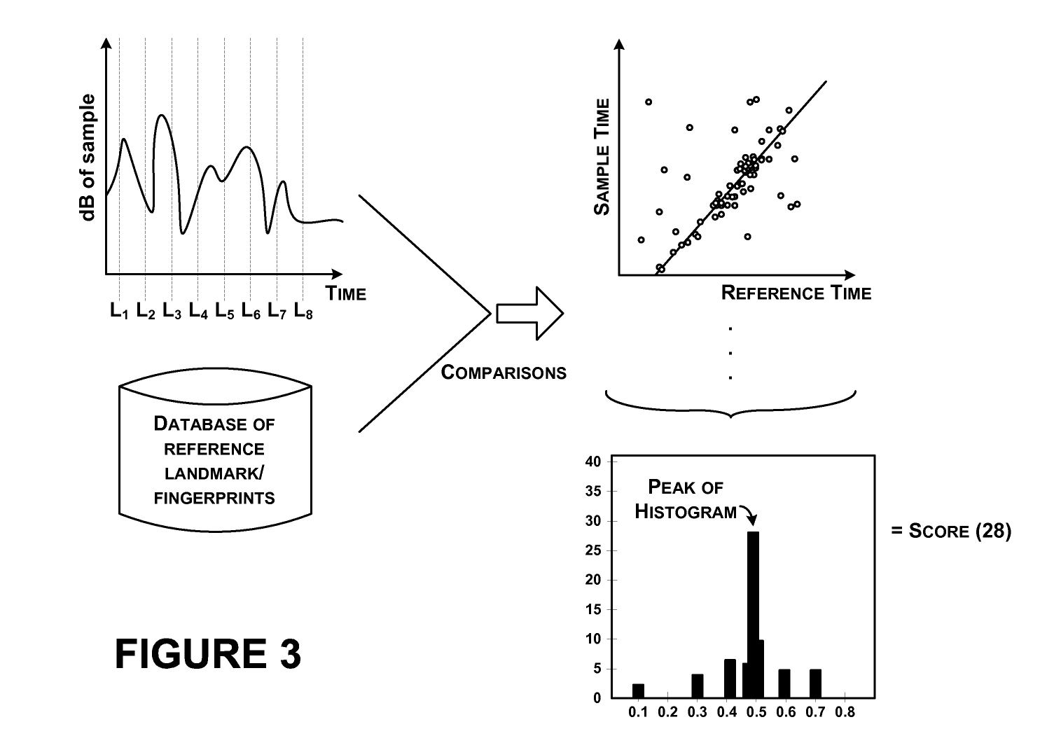

FIG. 3 illustrates another example content identification method. Generally, media content can be identified by identifying or computing characteristics or fingerprints of a media sample and comparing the fingerprints to previously identified fingerprints of reference media files. Particular locations within the sample at which fingerprints are computed may depend on reproducible points in the sample. Such reproducibly computable locations are referred to as “landmarks.” A location within the sample of the landmarks can be determined by the sample itself, i.e., is dependent upon sample qualities and is reproducible. That is, the same or similar landmarks may be computed for the same signal each time the process is repeated. A landmarking scheme may mark about 5 to about 10 landmarks per second of sound recording; however, landmarking density may depend on an amount of activity within the media recording. One landmarking technique, known as Power Norm, is to calculate an instantaneous power at many time points in the recording and to select local maxima. One way of doing this is to calculate an envelope by rectifying and filtering a waveform directly. Another way is to calculate a Hilbert transform (quadrature) of a signal and use a sum of magnitudes squared of the Hilbert transform and the original signal. Other methods for calculating landmarks may also be used.

FIG. 3 illustrates an example plot of dB (magnitude) of a sample vs. time. The plot illustrates a number of identified landmark positions (L₁ to L₈). Once the landmarks have been determined, a fingerprint is computed at or near each landmark time point in the recording. A nearness of a feature to a landmark is defined by the fingerprinting method used. In some cases, a feature is considered near a landmark if the feature clearly corresponds to the landmark and not to a previous or subsequent landmark. In other cases, features correspond to multiple adjacent landmarks. The fingerprint is generally a value or set of values that summarizes a set of features in the recording at or near the landmark time point. In one example, each fingerprint is a single numerical value that is a hashed function of multiple features. Other examples of fingerprints include spectral slice fingerprints, multi-slice fingerprints, LPC coefficients, cepstral coefficients, and frequency components of spectrogram peaks.

Fingerprints can be computed by any type of digital signal processing or frequency analysis of the signal. In one example, to generate spectral slice fingerprints, a frequency analysis is performed in the neighborhood of each landmark timepoint to extract the top several spectral peaks. A fingerprint value may then be the single frequency value of a strongest spectral peak. For more information on calculating characteristics or fingerprints of audio samples, the reader is referred to U.S. Pat. No. 6,990,453, to Wang and Smith, entitled “System and Methods for Recognizing Sound and Music Signals in High Noise and Distortion,” the entire disclosure of which is herein incorporated by reference as if fully set forth in this description.

Thus, referring back to FIG. 1, the client device 104 or the server 122 may receive a recording (e.g., media/data sample) and compute fingerprints of the recording. In one example, to identify information about the recording, the content identification module 112 of the client device 104 can then access the database 116 to match the fingerprints of the recording with fingerprints of known audio tracks by generating correspondences between equivalent fingerprints and files in the database 116 to locate a file that has a largest number of linearly related correspondences, or whose relative locations of characteristic fingerprints most closely match the relative locations of the same fingerprints of the recording.

Referring to FIG. 3, a scatter plot of landmarks of the sample and a reference file at which fingerprints match (or substantially match) is illustrated. The sample may be compared to a number of reference files to generate a number of scatter plots. After generating a scatter plot, linear correspondences between the landmark pairs can be identified, and sets can be scored according to the number of pairs that are linearly related. A linear correspondence may occur when a statistically significant number of corresponding sample locations and reference file locations can be described with substantially the same linear equation, within an allowed tolerance, for example. The file of the set with the highest statistically significant score, i.e., with the largest number of linearly related correspondences, is the winning file, and may be deemed the matching media file.

In one example, to generate a score for a file, a histogram of offset values can be generated. The offset values may be differences in landmark time positions between the sample and the reference file where a fingerprint matches. FIG. 3 illustrates an example histogram of offset values. The reference file may be given a score that is equal to the peak of the histogram (e.g., score=28 in FIG. 3). Each reference file can be processed in this manner to generate a score, and the reference file that has a highest score may be determined to be a match to the sample.

In addition, systems and methods described within the publications above may return more than an identity of a media sample. For example, using the method described in U.S. Pat. No. 6,990,453 to Wang and Smith may return, in addition to metadata associated with an identified audio track, a relative time offset (RTO) of a media sample from a beginning of an identified sample. To determine a relative time offset of the recording, fingerprints of the sample can be compared with fingerprints of the original files to which the fingerprints match. Each fingerprint occurs at a given time, so after matching fingerprints to identify the sample, a difference in time between a first fingerprint (of the matching fingerprint in the sample) and a first fingerprint of the stored original file will be a time offset of the sample, e.g., amount of time into a song. Thus, a relative time offset (e.g., 67 seconds into a song) at which the sample was taken can be determined. Other information may be used as well to determine the RTO. For example, a location of a histogram peak may be considered the time offset from a beginning of the reference recording to the beginning of the sample recording.

Other forms of content identification may also be performed depending on a type of the media sample. For example, a video identification algorithm may be used to identify a position within a video stream (e.g., a movie). An example video identification algorithm is described in Oostveen, J., et al., “Feature Extraction and a Database Strategy for Video Fingerprinting”, Lecture Notes in Computer Science, 2314, (Mar. 11, 2002), 117-128, the entire contents of which are herein incorporated by reference. For example, a position of the video sample into a video can be derived by determining which video frame was identified. To identify the video frame, frames of the media sample can be divided into a grid of rows and columns, and for each block of the grid, a mean of the luminance values of pixels is computed. A spatial filter can be applied to the computed mean luminance values to derive fingerprint bits for each block of the grid. The fingerprint bits can be used to uniquely identify the frame, and can be compared or matched to fingerprint bits of a database that includes known media. The extracted fingerprint bits from a frame may be referred to as sub-fingerprints, and a fingerprint block is a fixed number of sub-fingerprints from consecutive frames. Using the sub-fingerprints and fingerprint blocks, identification of video samples can be performed. Based on which frame the media sample included, a position into the video (e.g., time offset) can be determined

Furthermore, other forms of content identification may also be performed, such as using watermarking methods. A watermarking method can be used by the position identification module 110 of the client device 104 (and similarly by the position identification module 124 of the server 122) to determine the time offset such that the media stream may have embedded watermarks at intervals, and each watermark may specify a time or position of the watermark either directly, or indirectly via a database lookup, for example.

In some of the foregoing example content identification methods for implementing functions of the content identification module 112, a byproduct of the identification process may be a time offset of the media sample within the media stream. Thus, in such examples, the position identification module 110 may be the same as the content identification module 112, or functions of the position identification module 110 may be performed by the content identification module 112.

In some examples, the client device 104 or the server 122 may further access a media stream library database 132 through the network 120 to select a media stream corresponding to the sampled media that may then be returned to the client device 104 to be rendered by the client device 104. Information in the media stream library database 132, or the media stream library database 132 itself, may be included within the database 116.

An estimated time position of the media being rendered by the media rendering source 102 is determined by the position identification module 110 and used to determine a corresponding position within the selected media stream at which to render the selected media stream. When the client device 104 is triggered to capture a media sample, a timestamp (T₀) is recorded from a reference clock of the client device 104. The timestamp corresponding to a sampling time of the media sample is recorded as T₀ and may be referred to as the synchronization point. The sampling time may preferably be the beginning, but could also be an ending, middle, or any other predetermined time of the media sample. Thus, the media samples may be time-stamped so that a corresponding time offset within the media stream from a fixed arbitrary reference point in time is known. At any time t, an estimated real-time media stream position Tᵣ(t) is determined from the estimated identified media stream position T_{S} plus elapsed time since the time of the timestamp:

Tᵣ(t)=T_{S}+t−T₀ Equation (1)

Tᵣ(t) is an elapsed amount of time from a beginning of the media stream to a real-time position of the media stream as is currently being rendered. Thus, using T_{S} (i.e., the estimated elapsed amount of time from a beginning of the media stream to a position of the media stream based on the recorded sample), the Tᵣ(t) can be calculated. Tᵣ(t) is then used by the client device 104 to present selected media stream in synchrony with the media being rendered by the media rendering source 102. For example, the client device 104 may begin rendering the selected media stream at the time position Tᵣ(t), or at a position such that Tᵣ(t) amount of time has elapsed so as to render and present the selected media stream in synchrony with the media being rendered by the media rendering source 102.

In some embodiments, the estimated position Tᵣ(t) can be adjusted according to a speed adjustment ratio R. For example, methods described in U.S. Pat. No. 7,627,477, entitled “Robust and invariant audio pattern matching”, the entire contents of which are herein incorporated by reference, can be performed to identify the media sample, the estimated identified media stream position T_{S}, and a speed ratio R. To estimate the speed ratio R, cross-frequency ratios of variant parts of matching fingerprints are calculated, and because frequency is inversely proportional to time, a cross-time ratio is the reciprocal of the cross-frequency ratio. A cross-speed ratio R is the cross-frequency ratio (e.g., the reciprocal of the cross-time ratio).

The speed ratio R can be estimated using other methods as well. For example, multiple samples of the media can be captured, and content identification can be performed on each sample to obtain multiple estimated media stream positions T_{S}(k) at reference clock time T₀(k) for the k-th sample. Then, R could be estimated as:

$${R}_{k} = \frac{{T}_{S} ( k ) - {T}_{S} ( 1 )}{{T}_{0} ( k ) - {T}_{0} ( 1 )} \qquad Equation ( 2 )$$

To represent R as time-varying, the following equation may be used:

$${R}_{k} = \frac{{T}_{S} ( k ) - {T}_{S} ( k - 1 )}{{T}_{0} ( k ) - {T}_{0} ( k - 1 )} \qquad Equation ( 3 )$$

Thus, the speed ratio R can be calculated using the estimated time positions T_{S} over a span of time to determine the speed at which the media is being rendered by the media rendering source 102.

Using the speed ratio R, an estimate of the real-time media stream position can be calculated as:

T(t)=T_{S}+R(t−T₀) Equation (4)

The real-time media stream position indicates the position in time of the media sample. For example, if the media sample is from a song that has a length of four minutes, and if Tᵣ(t) is one minute, that indicates that the one minute of the song has elapsed. The time information may be determined by the client device during content identification.

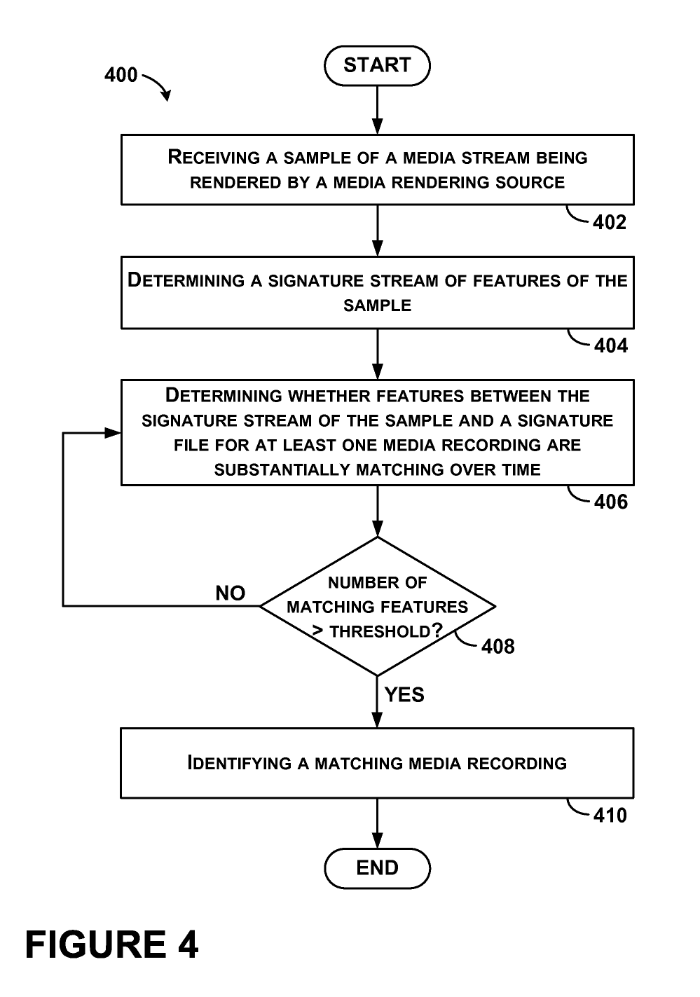

FIG. 4 shows a flowchart of an example method 400 for identifying content in a data stream. Method 400 shown in FIG. 4 presents an embodiment of a method that, for example, could be used with the system shown in FIG. 1, for example, and may be performed by a computing device (or components of a computing device) such as a client device or a server. Method 400 may include one or more operations, functions, or actions as illustrated by one or more of blocks 402-410. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block in FIG. 4 may represent circuitry that is wired to perform the specific logical functions in the process. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

The method 400 includes, at block 402, receiving a sample of a media stream at a client device. The client device may receive the media stream continuously, sporadically, or at intervals, and the media stream may include any type of data or media, such as a radio broadcast, television audio/video, or any audio being rendered. The media stream may be continuously rendered by a source, and thus, the client device may continuously receive the media stream. In some examples, the client device may receive a substantially continuous media stream, such that the client device receives a substantial portion of the media stream rendered, or such that the client device receives the media stream at substantially all times. The client device may capture a sample of the media stream using a microphone, for example.

The method 400 includes, at block 404, at the client device, determining a signature stream of features of the sample. For example, a client device may receive via an input interface (e.g., microphone) samples of the media stream in an incremental manner as a media stream is being received, and may extract features of these samples to generate corresponding signature stream increments. Each incremental sample may include content at a time after a previous sample, as the media stream rendered by the media rendering source may have been ongoing. The signature stream may be generated based on samples of the media stream using any of the methods described above for extracting features of a sample, for example.

The signature stream may be generated in an ongoing basis in real-time when the media stream is an ongoing media stream. In this manner, features in the signature stream may increase in number over time.

The method 400 includes, at block 406, determining whether features between the signature stream of the sample and a signature file for at least one media recording are substantially matching over time. For example, the client device may compare the features in the signature stream with features in stored signature files. The features in the signature stream may be or include landmark-fingerprint pairs, and the signature files may include landmark-fingerprint pairs for a given reference file, for example. Thus, the client device may perform comparisons of landmark-fingerprint pairs of the signature stream and signature files.

The method 400 includes, at block 408, determining whether a number of matching features is above a threshold, and based on the number of matching features, identifying a matching media recording at block 410. For example, the client device may be configured to determine a number of matching features between the signature stream of the media sample and stored signature files, and rank the number of matching features for each signature file. A signature file that has a highest number of matching features may be considered a match, and a media recording that is identified by or referenced by the signature file may be identified as a matching recording for the sample.

In one example, block 406 may be repeated after block 408 when the number of matching features is less than a threshold, such that features between the signature stream and the signature files can be repeatedly compared. Over time, when a media stream is continuously received, the client device may receive more content for the signature stream (e.g., a longer portion of a song), and accumulation of data may be processed in aggregate with results from processing earlier segments to look for matches within longer samples.

The client device may receive the media stream continuously and may continuously perform content identifications based on comparisons with stored signature files. In this manner, the client device may attempt to identify all content that is received. The content identifications may be substantially continuously performed, such that content identifications are performed at all times or substantially all the time while the client device is operating, or while an application comprising content identification functions is running, for example.

In some examples, content identifications can be performed upon receiving the media stream. The client device may be configured to continuously receive a data stream from a microphone (e.g., always capture ambient audio). The client device may be configured to continuously perform the content identifications so as to perform a passive content identification without user input (e.g., the user does not have to trigger the client device to perform the content identification). A user of the client device may initiate an application that continuously performs the content identifications or may configure a setting on the client device such that the client device continuously performs the content identifications.

Using the method 400 in FIG. 4, featured content may be identified locally by the client device (based on locally stored content patterns). The method 400 enables all content identification processing to be performed on the client device (e.g., extract features of the sample, search limited set of signature files stored on the phone, etc.). For example, for promotions, signature files related to content of the promotions can be provided to the client device (e.g., preloaded on the client device), and the client device may be configured to operate in a continuous recognition mode and be able to identify this limited set of content.

In one example, when featured content is captured by the client device, the client device can perform the content identification and provide a notification (e.g., pop-up window) indicating recognition. The method 400 may provide a zero-click (e.g., passive) tagging experience for users to notify users when featured content is identified.

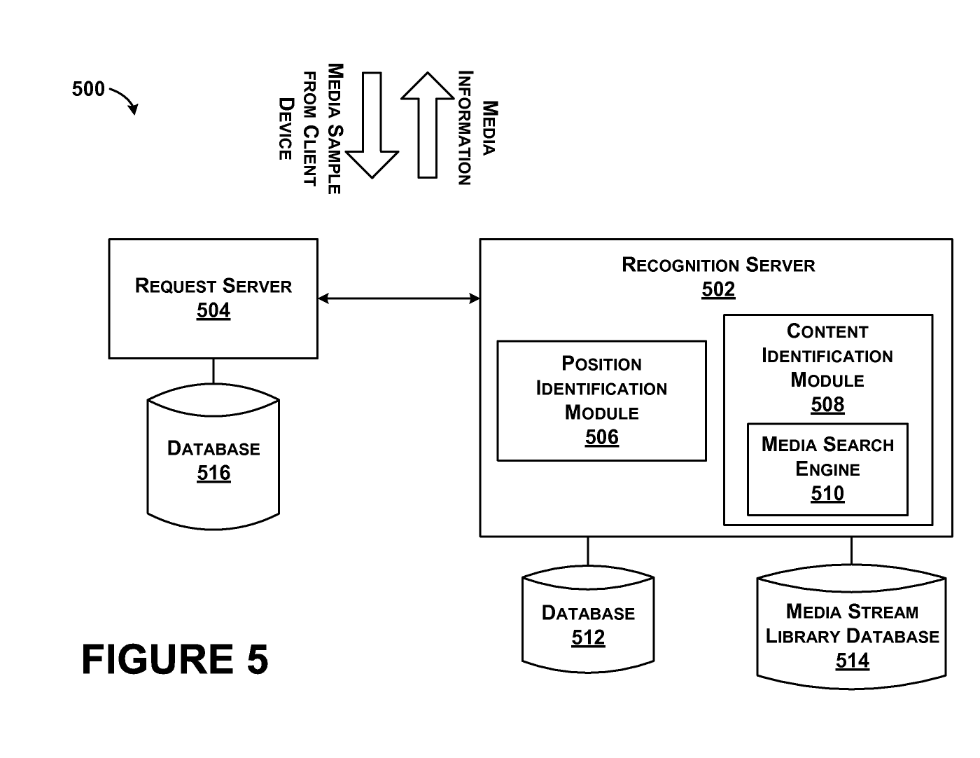

FIG. 5 illustrates an example system 500 for identifying content in a data stream and determining signature files for a client device. One or more of the described functions or components of the system in FIG. 5 may be divided up into additional functional or physical components, or combined into fewer functional or physical components. In some further examples, additional functional and/or physical components may be added to the examples illustrated by FIG. 5.

The system 500 includes a recognition server 502 and a request server 504. The recognition server 502 may be configured to receive from a client device a query to determine an identity of content, and the query may include a sample of the content. The recognition server 502 includes a position identification module 506, a content identification module 508 including a media search engine 510, and is coupled to a database 512 and a media stream library database 514. The recognition server 504 may be configured to operate similar to the server 122 in FIG. 1, for example.

The request server 504 may be configured to instruct the client device to operate in a continuous identification mode, such that the client device continuously performs content identifications of content within a received data stream at the client device in the continuous identification mode (rather than or in addition to sending queries to the recognition server 502 to identify content). The request server 504 may be coupled to a database 516 that includes content patterns or signature files, and the request server 504 may access the database 516 to retrieve content patterns and send the content patterns to the client device.

In one example, the request server 504 may send the client device one or more signature files, and optionally an instruction to continuously perform content identifications of content in a media stream at the client device. The client device may responsively operate in a continuous mode. The request server 504 may send the instruction to the client device during times when the recognition server 502 is experiencing a high volume of content identification requests, and thus, the request server 502 performs load balancing by instructing some client devices to locally perform content identifications. Example times when a high volume of requests may be received include when a song or an advertisement is being run on a television during a time when a large audience is tuned to the television. In such instances, the request server 504 can plan ahead, and provide signature files matching the song or the advertisement to be rendered during the show to the client device and include an instruction for the client device to perform the content identification locally. The instruction may include an indication of when the client device should perform local content identifications, such as to instruct to do so at a future time and for a duration of time. In some examples, for promotions, signature files can be provided to the client device to have a local cache of files (e.g., about 100 to 500 files), and the instruction can indicate to the client device to perform content identifications locally for as long as the promotions run.

In some examples, the request server 504 may provide one or more signature files to the client device. The request server 504 may send a database of signatures/fingerprints to the client device to enable the client device to identify content in a standalone way without connecting to the request server 504. In other examples, the request server 504 may provide raw content or recordings to the client device, and the client device may extract signatures from the raw content to populate a local database on the client device.

Signature files to be provided to the client device can be selected by the request server 504 based on a number of criteria. For example, the request server 504 may receive information related to a user's profile, and may select signature files to be provided to the client device that are correlated to the user's profile. Specifically, a user may indicate a preference for a certain genre of music, artists, type of music, sources of music, etc., and the request server 504 may provide signature files for media correlated to these preferences, and also may provide an amount of content based on a predetermined storage limit available on the client device to store signature files.

As another example, the request server 504 may receive information related to a location (past or current) of a client device, and may select signature files to be provided to the client device that are associated with the location of the client device. Specifically, the request server 404 may receive information indicating that the client device is located at a concert, and may select signature files associated with music of genre or the artist at the concert to be provided to the client device. In another example, other granularities of physical or geographic locations of the client device may be used to select which signature files from among a large set or pool of signature files are provided to the client device, such as based on being located in a given country (e.g., provide signature files corresponding to songs of local preferences), a given state or a given county.

Other types of location may be used as well for selective determinations including a network address location, such as when a client device is connected to a network via a Wi-Fi network node, a MAC address may be used as a location. Similarly, network or wireless addresses associated with Bluetooth or RFID devices may be used. Any network address may be determined and cross-referenced with a location database to determine a physical location of the client device.

In still further examples, a device type or configuration type may be used as a basis for selecting signature files to send to the device. For instance, certain device types or configuration types may be associated with uses of devices in a given country or with a given service provider (which operates in a known area), and such information may be used to determine or infer locations of a client device.

As another example, the request server 504 may receive information related to media content stored on the client device, and may select signature files to be provided to the client device that are related to the media content stored on the client device. Signature files may be related in many ways, such as, by artist, genre, type, year, tempo, etc.

As another example, the request server 504 may receive information related to previously identified media content by the client device, and may select signature files to be provided to the client device that are related to content previously identified by the client device or the recognition server 502. In this example, the request server 504 may store a list of content identified by the client device or by the recognition server 502 so as to select and provide content patterns related to identified content.

As another example, the request server 504 may select signature files to be provided to the client device based on information received by a third party. The third party may provide selections to the request server 504 so as to select the signature files that are provided to the client device. In one example, a third party advertiser may select signature files based on content to be included within future advertisements to be run within radio or television ads.

As another example, the request server 504 may select signature files to be provided to the client device based on a ranking signature files in a database according to a listing of purchased songs associated with a user profile of the client device. For example, the request server 504 may receive from a digital media service provider the listing of songs according to the user profile, and may select signature files of songs of the same genre, artist, category, etc.

As another example, the request server 504 may select content patterns to be provided to the client device that are based on a statistical profile indicating a popularity of pieces of content pertaining to a history of content identifications. In this example, the request server 404 may maintain a list of media content identified by the recognition server 502, and may rank a popularity of media content based on a number of content identification requests for each media content. For media content that have received a number of content identification requests above a threshold (e.g., 1000 requests within a given time period), the request server 504 may select signature files of those media content and provide the signature files to the client device. In this manner, the client device will have a local copy of the signature file and may perform the content identification locally.

In still further examples, the request server 504 may select signature files to be provided to the client device that are based on any combination of criteria, such as based on a location of the client device and selected signature files received from a third party (e.g., a third party identifies a number of signature files to be provided to client devices based on their location).

Generally, within some examples, the request server 504 may be configured to select signature files to be provided to the client device based on a probability that the client device (or a user of the client device) will request a content identification of the selected content. For example, for new or popular songs that have been released, or for which the recognition server 502 has received a spike in content identification requests over the past day, the request server 504 may provide signature files of those songs to the client device so that the client device can perform a local content identification without the need of communicating with the recognition server 502. This may offload traffic from the recognition server 502 as well as enable a content identification to be performed more quickly by performing the content identification locally on the client device. Thus, in some examples, a probabilistically ranking database of media can be generated according to frequency of tagging. For example, the recognition server 502 may determine statistics of most popular content identification requests, and may provide signature files of media corresponding to the requests to client devices so that the client devices may perform the content identifications.

In some examples, when a client device connects to a recognition server, the recognition server may provide a number of signature files to the client device (e.g., about 20 MB of content, which may include about 1000 signature files of songs and information for the songs). In one example, the recognition server (or another connection server) may determine if and when the client device is in communication with the recognition server over a selected communication channel (e.g., a broadband or WiFi connection), and the recognition server may then use the selected communication channel to transfer the signature files to the client device to avoid transfer of data over a slower, more congested communication channel and/or to avoid burdening users on limited data plans. In some instances, the recognition server may determine that a communication interface between the server and the client device includes a sufficient amount of bandwidth for transfer of the set of signature files. In some instances, the recognition server may determine that the communication interface is made via a cellular wireless network provided by a cellular wireless provider, and may provide the set of signature files to the client device upon a determination that the communication interface is made via a local wired or wireless broadband connection (WiFi).

Recognition requests performed by the client devices may take load off of the recognition server and may also provide for more instantaneous recognitions to occur (e.g., no need to communicate with a server). The recognition server may selectively determine signature files to send to a client device for client device content recognition (to prepare a local cache of potential identifications), in contrast to the recognition server performing and responding to all content recognition requests.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

What is claimed is:

1. A method comprising:
receiving at a client device a signature file, wherein the signature file is indicative of one or more features extracted from media content and information identifying the media content; and
based on a comparison with the signature file, the client device performing a content identification of received media content rendered by a media rendering source.

2. The method of claim 1, wherein the signature file includes a temporally mapped collection of the one or more features extracted the media content, wherein each of the one or more features describes the media content in a vicinity of a mapped timepoint.

3. The method of claim 1, wherein the one or more features extracted from the media content correspond to peak values in a spectrogram of the media content where corresponding energy values are local maximums, and the signature file includes pairs of the peak values and corresponding time locations.

4. The method of claim 1, wherein the one or more features extracted from the media content correspond to spectrogram bitmap rasters in a spectrogram of the media content.

5. The method of claim 1, wherein the peak values in the spectrogram of the media content correspond to be between about 10 to about 50 peak values per second.

6. The method of claim 1, further comprising receiving at the client device a set of signature files corresponding to a plurality of media content, wherein the plurality of media content is based on a physical location of the client device.

7. The method of claim 1, further comprising receiving at the client device a set of signature files corresponding to a plurality of media content, wherein the plurality of media content is based on a network address of the client device.

8. The method of claim 1, further comprising receiving at the client device a set of signature files corresponding to a plurality of media content, wherein the plurality of media content is based on factors selected from the group consisting of a previous content recognition request of the client device, a genre preference, an artist preference, and a user profile.

9. The method of claim 1, further comprising receiving at the client device a set of signature files corresponding to a plurality of media content, wherein the plurality of media content is based on a statistical ranking of popular media content.

10. The method of claim 1, further comprising the client device receiving the media content rendered by the media rendering source using a microphone.

11. The method of claim 1, further comprising the client device receiving the media content rendered by the media rendering source on a continuous basis.

12. The method of claim 1, wherein the client device performing the content identification of the received media content rendered by the media rendering source comprises:
determining one or more features of the received media content; and
comparing the one or more features of the received media content with the one or more features extracted from media content as indicated by the signature file to determine a match of one or more features.

13. The method of claim 12, wherein determining the one or more features of the received media content comprises determining a set of fingerprints of the received media content, each fingerprint associated with a landmark within the received media content.

14. The method of claim 1, wherein receiving at the client device the signature file comprises receiving the signature file from a server.

15. The method of claim 14, wherein the client device includes a database storing a plurality of signature files, wherein the signature file is one of the plurality of signature files, and where the method further comprises receiving from the server at the client device an update to the database, wherein the update includes one or more new signature files to incorporate into the database or an instruction to remove one or more existing signature files from the database.

16. The method of claim 1, wherein receiving at the client device the signature file comprises:
receiving at the client device the media content; and
processing, by the client device, the media content to generate the signature file for the media content.

17. A non-transitory computer readable medium having stored therein instructions executable by a client device to cause the client device to perform functions comprising:
receiving at the client device a signature file, wherein the signature file is indicative of one or more features extracted from media content and information identifying the media content; and
based on a comparison with the signature file, the client device performing a content identification of received media content rendered by a media rendering source.

18. The non-transitory computer readable medium of claim 17, wherein the instructions are further executable by the client device to cause the client device to perform functions comprising:
determining a set of fingerprints of the received media content, each fingerprint associated with a landmark within the received media content; and
comparing the set of fingerprint of the received media content with the one or more features extracted from media content as indicated by the signature file to determine a match of one or more features.

19. A client device comprising:
a database configured to receive and incorporate a signature file, wherein the signature file is indicative of one or more features extracted from media content and information identifying the media content; and
a content identification module coupled to the database and configured to perform a content identification of received media content rendered by a media rendering source based on a comparison with the signature file.

20. The client device of claim 19, wherein the database is further configured to receive a set of signature files corresponding to a plurality of media content, wherein the plurality of media content is based on one or more of a type of the client device or a configuration of the client device, wherein the type of the client device or the configuration of the client device is indicative of a given location or a given service provider of the client device.

21. The client device of claim 19, further comprising a microphone configured to receive the media content rendered by the media rendering source.

22. A method comprising:
determining, by a server, a set of signature files from a database of signature files for a client device, wherein each signature file is indicative of one or more features extracted from a respective media content and information associated with the respective media content; and
providing the set of signature files to the client device.

23. The method of claim 22, wherein the information identifying the respective media content includes one or more of a title of a song, an artist of the song, and a genre of a song.

24. The method of claim 22, wherein each signature file includes a fingerprint of the respective media content associated with a landmark within the respective media content.

25. The method of claim 22, wherein providing the set of signature files to the client device comprises:
the server identifying a communication interface to the client device; and
determining that the communication interface includes a sufficient amount of bandwidth for transfer of the set of signature files.

26. The method of claim 25, wherein determining that the communication interface includes the sufficient amount of bandwidth for transfer of the set of signature files comprises determining that the communication interface is made via a local wireless broadband connection (WiFi).

27. The method of claim 25, wherein providing the set of signature files to the client device comprises:
the server identifying a communication interface to the client device;
determining that the communication interface is made via a cellular wireless network provided by a cellular wireless provider; and
providing the set of signature files to the client device upon a determination that the communication interface is made via a local wireless broadband connection.

28. The method of claim 22, wherein the respective media content includes a song, and the method further comprising:
the server ranking signature files in a database according to a listing of purchased songs associated with the user profile and provided by a digital media service provider; and
determining the set of signature files to the client device based on the ranking

29. The method of claim 22, wherein determining the set of signature files for the client device comprises determining signature files to include in the set of signature files based on a location of the client device.

30. The method of claim 22, wherein determining the set of signature files for the client device comprises determining signature files to include in the set of signature files based on previous content identification requests received at the server and requested by the client device.

31. The method of claim 22, wherein determining the set of signature files for the client device comprises determining signature files to include in the set of signature files based on media content stored on the client device.

32. The method of claim 22, wherein determining the set of signature files for the client device comprises determining signature files to include in the set of signature files based on one or more of a genre preference, an artist preference, and a date of origination of the respective media content.

33. The method of claim 22, wherein determining the set of signature files for the client device comprises determining a plurality of signature files based on a predetermined storage limit for the set of signature files at the client device.

34. The method of claim 22, further comprising providing with the set of signature files a set of advertisements related to the respective media content.

35. The method of claim 22, wherein determining the set of signature files from the database of signature files for the client device comprises determining signature files to include in the set of signature files based on a statistical profile indicating a popularity of pieces of media content.

36. The method of claim 22, wherein determining the set of signature files from the database of signature files for the client device comprises determining signature files to include in the set of signature files based on a statistical profile pertaining to a history of content identification requests requested at the server.

37. The method of claim 22, further comprising:
the server receiving a plurality of content identification requests, wherein the content identification requests each include a sample of the content;
the server ranking signature files in a database based on a frequency of media content, to which the signature files correspond, has been a subject of the plurality of content identification requests; and
providing the set of signature files to the client device based on the ranking

38. A non-transitory computer readable medium having stored therein instructions executable by a computing device to cause the computing device to perform functions comprising:
determining, by the computing device, a set of signature files from a database of signature files for a client device, wherein each signature file is indicative of one or more features extracted from a respective media content and information associated with the respective media content; and
providing the set of signature files to the client device.

39. The non-transitory computer readable medium of claim 38, wherein each signature file includes a fingerprint of the respective media content associated with a landmark within the respective media content.

40. The non-transitory computer readable medium of claim 38, wherein the instructions are further executable by the computing device to cause the computing device to perform functions comprising determining signature files to include in the set of signature files based on a statistical profile pertaining to a history of content identification requests requested at the computing device.

41. A server comprising:
a database configured to store signature files, wherein each signature file is indicative of one or more features extracted from a respective media content and information associated with the respective media content; and
a content identification module coupled to the database and configured to determine a set of signature files from the stored signature files for a client device, and to provide the set of signature files to the client device to enable the client device to perform a content identification of received media content.

42. The server of claim 41, wherein the content identification module is further configured to determine the set of signature files from the database of signature files for the client device based on a statistical profile pertaining to a history of content identification requests of media content received at the server.
